(19) United States
(12) Patent Application Publication
(10) Pub. No.: US 2010/0121790 A1
(43) Pub. Date: May 13, 2010

(54) METHOD, APPARATUS AND COMPUTER PROGRAM PRODUCT FOR CATEGORIZING WEB CONTENT

(76) Inventor: Dennis Klinkott, Munchen (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/270,356

(22) Filed: Nov. 13, 2008

(51) Int. Cl. G06F 15/18; G06F 7/00; G06F 17/30

(52) U.S. Cl. 706/12; 707/E17.046

(57) ABSTRACT

An apparatus for providing web content categorization may include a processor configured to receive an indication of a web page to be evaluated, evaluate the web page based on characteristics of the web page in relation to previously categorized web pages assigned to respective ones of a structured group of categories, and assign the web page to at least one of the categories based on the evaluation. A corresponding method and computer program product are also provided.

### TECHNOLOGICAL FIELD

Embodiments of the present invention relate generally to content classification technology and, more particularly, relate to an apparatus, method and a computer program product for categorizing web content, such as web pages.

### BACKGROUND

Communication networks such as the Internet or World Wide Web (“web”) may include vast amounts of information. However, locating a particular item or portion of the information can present a challenge. Moreover, with the continuous expansion of the amount of information on the web, the challenge continues to grow as well.

The information a particular user may desire to access can be obtained in a number of ways. In some cases, users may simply follow a series of known or discovered links on various web pages to desirable information that may be found on other web pages. In other cases, users may search for the information they desire by providing a search term or query to a search engine. In still other cases, the user may pose a question for which the user would like to have an answer.

Two examples of popular ways of searching for information include search engines and directories. Search engines may provide hyperlinks to web pages and to elements on web pages (e.g., images or other objects) in which a user may have interest. In some cases, search engines base their determination of the user's interest on search terms (e.g., a search query) entered by the user. In this regard, for example, the search engine may provide the user with links to high quality, relevant results based on the search query. In some cases, the search engine may accomplish this by matching the terms in the search query to a corpus of pre-stored web pages. Web pages that contain the user's search terms may be returned to the user as “hits”.

Though widely improved in the last ten years, today's search engines still use the same underlying concepts as their earlier counterparts in order to provide the user with information related to an entered search query. For example, current search engines typically provide a list of search results displayed in an ordered fashion. In this regard, for example, the search results may be ordered by general popularity of the respective website and selected if the search words occur at a prominent location on the page, such as in the title of the page. If a user is looking for information that is of interest also to an average user, these search engines may provide reasonable results. However, if a user is looking for something specific, that might be of high importance to him but not to the average user, today's search engines often do not deliver the desired result among the first 100 search results because they rank the results according to the general popularity of the website.

Furthermore, a list of search results displayed and sorted by the overall popularity of a website might lead to the desired results in cases where the search query was very specific. However, in cases where a search term is rather unspecific, the list of search results may be a mix of web pages belonging to a wide array of different topics and different semantic interpretations of the same word. The sorting criteria ‘general popularity’ may therefore not structure the display of search results in a way that would appear logical. In order to find the desired result, the user may need to either click through many pages of search results or further refine the search terms. Both of these operations may be considered tedious tasks by many users. Furthermore, success in using these approaches may depend highly on the user's imagination with respect to selection of appropriate search terms.

Other approaches to introducing further criteria have also been developed, such as clustering. Clusty.com is an example for a meta-search engine that employs clustering. Clusty.com uses words on the page to define in which cluster to put a webpage. It then displays a page including a cluster tree, which allows narrowing the search results by clicking on a cluster name in the cluster tree, and subsequently getting the results of the selected cluster displayed. While the cluster names are displayed as a cluster tree on the left part of the page, the main part of the page includes search results of all subcategories mixed together.

Clustering in this manner may not be desirable in some cases. For example, in defining clusters, reliance may be placed on evaluating words on pages that are returned as a response to the search request. Since the words on a page are only in the control of the author of the respective page, this information is not objective in any way and the quality of the assignment of web pages to clusters may be barely reliable. Additionally, clustering including only filtering the search results but not providing an ordering of the results by cluster may not be desirable in some cases. For example, if a category or a subcategory is selected, the selection may determine which search results are being displayed but may not affect in which order they are displayed. Search results on the main part of the page may be displayed as a list of search results that, although being part of a sub-cluster, are not displayed in relation to that sub-cluster, but rather are displayed as an apparently unsorted list of search results mixed across various sub-clusters.

As indicated above, directories that guide the user to popular addresses in the Internet by offering them web pages sorted by categories for an alternative to search engines. Directories are usually manually edited, which is aimed at assuring their high quality of categorization. DMOZ is an example for a directory administered under an open source license. In contrast to search engines, even big directories typically only cover a few million indexed pages which is much less than 0.1 percent of all existing web pages. While directories may provide a good logical structure to group pages in the web into categories, directories lack popularity due to the very limited amount of web pages they contain. If one is looking for something less popular but maybe important to the specific user, it may be common, or even highly likely, that the web page is not included at all in the directory and hence, the desired result may not be found.

Based on the shortcomings described above, it may be desirable to develop improved mechanisms for categorizing web content.

### BRIEF SUMMARY

A method, apparatus and computer program product are therefore provided that may enable the categorization of web content, such as web pages. In an exemplary embodiment, categorization of documents may be accomplished by evaluating uncategorized web pages in relation to characteristics associated with web pages that have been previously categorized. For example, the evaluation may include comparing a portion (e.g., a beginning portion) of address information (e.g., a uniform resource locator (URL)) associated with a particular web page to address information (e.g., a URL) of other web pages that are already assigned to a category. A web page that is determined to most closely match the address information of the particular web page may then be selected so that the particular web page may be assigned to the same category as the particular web page. Alternatively, pages that link to a web page, or that the web page links to, may be evaluated to determine whether the web page should be assigned the same or a more general level category related to the pages.

In an exemplary embodiment, a method of providing a categorization of web content is provided. The method may include receiving an indication of a web page to be evaluated, evaluating (e.g., using a processor configured to perform the evaluation) the web page based on characteristics of the web page in relation to previously categorized web pages assigned to respective ones of a structured group of categories, and assigning the web page to at least one of the categories based on the evaluation.

In another exemplary embodiment, a computer program product for providing a categorization of web content is provided. The computer program product includes at least one computer-readable storage medium having computer-executable program code instructions stored therein. The computer-executable program code instructions may include program code instructions for receiving an indication of a web page to be evaluated, evaluating the web page based on characteristics of the web page in relation to previously categorized web pages assigned to respective ones of a structured group of categories, and assigning the web page to at least one of the categories based on the evaluation.

In another exemplary embodiment, an apparatus for providing a categorization of web content is provided. The apparatus may include a processor. The processor may be configured to receive an indication of a web page to be evaluated, evaluate the web page based on characteristics of the web page in relation to previously categorized web pages assigned to respective ones of a structured group of categories, and assign the web page to at least one of the categories based on the evaluation.

Accordingly, embodiments of the present invention may enable improved capabilities for users to search for and locate desirable content.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a system according to an exemplary embodiment of the present invention;

FIG. 2 is a schematic block diagram of an apparatus for providing categorization of web content according to an exemplary embodiment of the present invention; and

FIG. 3 is a flowchart according to an exemplary method for providing categorization of web content according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Additionally, numerous URLs are described herein by way of example in order to assist in the explanation of various embodiments of the present invention. The URLs described are merely used for exemplary purposes and are not provided in order to hyperlink to any particular content, or comment on the content of any particular web page. As such, the examples listed herein should not be taken to be limiting to the concepts of embodiments of the present invention, but should be appreciated as non-limiting examples of data that may be used for practicing embodiments of the present invention.

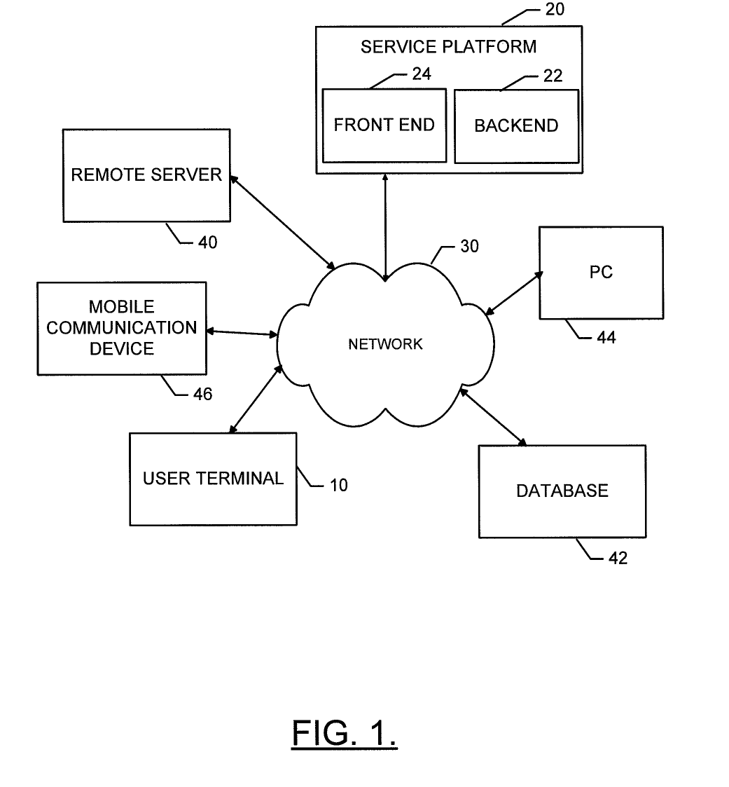

FIG. 1 illustrates a block diagram of a system that may benefit from embodiments of the present invention. It should be understood, however, that the system as illustrated and hereinafter described is merely illustrative of one system that may benefit from embodiments of the present invention and, therefore, should not be taken to limit the scope of embodiments of the present invention. As shown in FIG. 1, an embodiment of a system in accordance with an example embodiment of the present invention may include a user terminal 10 capable of communication with numerous other devices including, for example, a service platform 20 via a network 30. In some embodiments of the present invention, the system may further include one or more additional devices such as personal computers (PCs), servers, mobile communication devices, databases, and/or the like (e.g., remote server 40, database 42, PC 44, mobile communication device 46 and others), that are capable of communication with the user terminal 10 and accessible by the service platform 20. However, not all systems that employ embodiments of the present invention may comprise all the devices illustrated and/or described herein.

The user terminal 10 may be any of multiple types of mobile or fixed communication and/or computing devices such as, for example, PCs, gaming devices, laptop computers, mobile telephones, personal digital assistants (PDAs), or any combination of the aforementioned, and/or other types of voice and text communications devices. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of wireless communication protocols. Thus, the network 30 may be a cellular network, a mobile network and/or a data network, such as a local area network (LAN), a metropolitan area network (MAN), and/or a wide area network (WAN), e.g., the Internet. In turn, other devices such as processing elements (e.g., personal computers, server computers or the like) may be included in or coupled to the network 30. By directly or indirectly connecting the user terminal 10 and the other devices (e.g., service platform 20, remote server 40, database 42, PC 44, mobile communication device 46) to the network 30, the user terminal 10 and/or the other devices may be enabled to communicate with each other, for example, according to numerous communication protocols including Hypertext Transfer Protocol (HTTP) and/or the like, to thereby carry out various communication or other functions of the user terminal 10 and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like.

In an example embodiment, the service platform 20 may be a device or node such as a server or other processing element. The service platform 20 may have any number of functions or associations with various services. As such, for example, the service platform 20 may be a platform such as a dedicated server (or server bank) associated with a particular information source or service (e.g., a categorization and/or search service). In this regard, for example, the service platform may include a backend 22 and a front end 24, each of which may be configured to provide data processing and/or service provision functionality in accordance with exemplary embodiments of the present invention. As such, the service platform 20 may represent a plurality of different services or information sources. Meanwhile, the backend 22 and the front end 24 may be specifically associated with corresponding functionality as described below. The functionality of the backend 22 and the front end 24 of the service platform 20 may be provided by hardware and/or software components configured to operate in accordance with embodiments of the present invention for the solicitation and/or provision of information from/to users of communication devices (e.g., the user terminal 10).

In an exemplary embodiment, the front end 24 may be configured to handle receipt of user input (e.g., a search query from the user terminal 10), processing of the search query to obtain search results and the provision of the search results to the user. As such, for example, the front end 24 may include hardware and/or software configured to receive the search query and obtain search results using a known search engine (e.g., Google, Yahoo, or any of various other search engines) in which the search results obtained are associated with categories assigned by the backend 22 in accordance with an embodiment of the present invention. The front end 24 may then be configured to provide the search results, as categorized according to categorization done by the backend 22, to the user of the user terminal 10 by any suitable mechanism. In this regard, for example, the front end 24 may be configured to calculate and present search results to the user by making use of categorization information.

The backend 22 may be configured to handle categorizing web content (e.g., web pages). In an exemplary embodiment, the backend 22 may utilize previously established or predefined categorizations to conduct categorizations of web content that has not yet been categorized. As such, for example, the backend 22 may compare information about particular web content (e.g., a web page that has not yet been categorized) to information about other web content (e.g., web pages that have been previously categorized) in order to determine with which category the particular web page should be associated. The backend 22 may also (or alternatively) incorporate other information into determinations regarding categorization of the particular web content. For example, categorizations may be performed on the basis of determining which categories the particular web page links to and assigning a category that matches or is otherwise determinable from the categories assigned to the web pages linked to by the particular web page. As an alternative, the backend 22 may examine the web pages from which the particular web page is linked and assign a category to the particular web page based on the categories of any pages that themselves link to the particular web page. In an exemplary embodiment, the backend 22 may be configured to examine web content accessible throughout the network 30. As such, the backend 22 may categorize content accessible from any of the devices in communication with the network 30 (e.g., remote server 40, database 42, PC 44, mobile communication device 46 and many others).

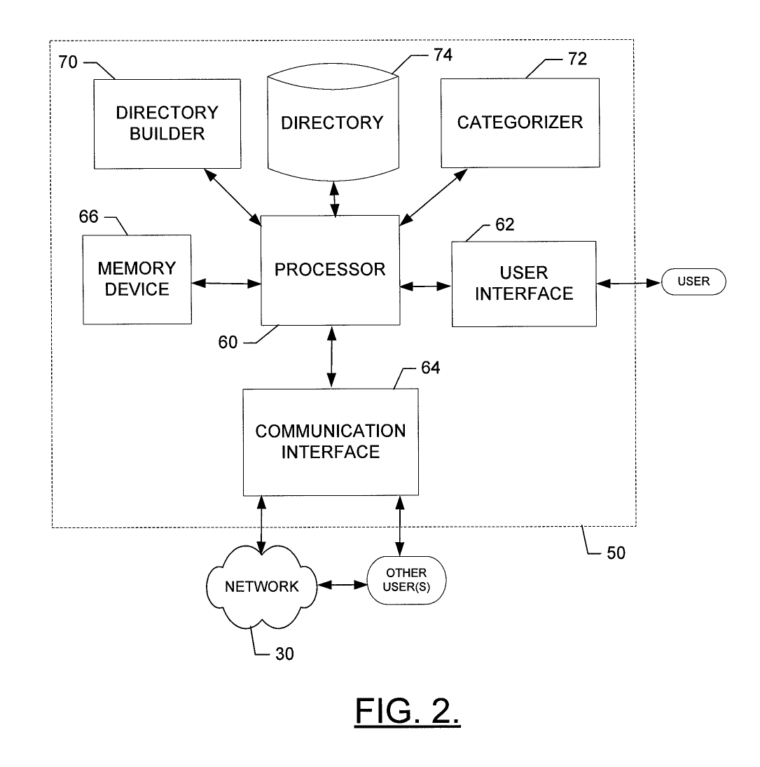

FIG. 2 illustrates a schematic block diagram of an apparatus for providing web content categorization according to an exemplary embodiment of the present invention. An exemplary embodiment of the invention will now be described with reference to FIG. 2, in which certain elements of an apparatus 50 for providing web content categorization are displayed. The apparatus 50 of FIG. 2 may be employed, for example, on the service platform 20, and more specifically on the backend 22, of FIG. 1. However, the apparatus 50 may alternatively be embodied at a variety of other devices. As such, in some cases, embodiments may be employed on a combination of devices (e.g., in a distributed fashion or in a client/server relationship). Furthermore, it should be noted that the devices or elements described below may not be mandatory and thus some may be omitted in certain embodiments.

Referring now to FIG. 2, an apparatus for providing web content categorization is provided. The apparatus 50 may include or otherwise be in communication with a processor 60, a user interface 62, a communication interface 64 and a memory device 66. The memory device 66 may include, for example, volatile and/or non-volatile memory. The memory device 66 may be configured to store information, data, applications, instructions and/or the like. For example, the memory device 66 could be configured to buffer input data for processing by the processor 60. Additionally or alternatively, the memory device 66 could be configured to store instructions for execution by the processor 60. As yet another alternative, the memory device 66 may be one of a plurality of databases that store information and/or web or media content.

The processor 60 may be embodied in a number of different ways. For example, the processor 60 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 60 may be configured to execute instructions stored in the memory device 66 or otherwise accessible to the processor 60. In some embodiments, the processor 60 (and/or the user interface 62, the communication interface 64 and the memory device 66) of the apparatus 50 may be shared between the front end 24 and the backend 22. However, in other embodiments, some or all of such devices or components may be replicated or separately embodied at each of the front end 24 and backend 22.

The communication interface 64 may be any means such as a device or circuitry embodied in either hardware, software, or a combination of hardware and software that is configured to receive and/or transmit data from/to a network (e.g., the network 30) and/or any other device or module in communication with the apparatus 50. In this regard, the communication interface 64 may include, for example, an antenna (or multiple antennas) and supporting hardware and/or software for enabling communications with a wireless communication network. In fixed environments, the communication interface 64 may alternatively or also support wired communication. As such, the communication interface 64 may include a communication modem and/or other hardware/software for supporting communication via cable, digital subscriber line (DSL), universal serial bus (USB), Ethernet or other mechanisms.

The user interface 62 may be in communication with the processor 60 to receive an indication of a user input at the user interface 62 and/or to provide an audible, visual, mechanical or other output to the user. As such, the user interface 62 may include, for example, a keyboard, a mouse, a joystick, a display, a touch screen, a microphone, a speaker, or other input/output mechanisms. In an exemplary embodiment in which the apparatus 50 is embodied as a server or some other network devices, the user interface 62 may be limited, or even eliminated.

In an exemplary embodiment, the processor 60 may be embodied as, include or otherwise control a directory builder 70 and a categorizer 72. As such, the directory builder 70 and the categorizer 72 may in some cases each be separate devices, modules, or functional elements. However, in other embodiments, some or all of the directory builder 70 and the categorizer 72 may be embodied within a single device, module, or functional element, such as the processor 60. The directory builder 70 and the categorizer 72 may each be any means such as a device or circuitry embodied in hardware, software or a combination of hardware and software (e.g., processor 60 operating under software control) that is configured to perform the corresponding functions of the directory builder 70 and the categorizer 72, respectively, as described below. Accordingly, the directory builder 70 and the categorizer 72 may each be specific functional components configured to perform processing as defined herein of specific data (e.g., web pages and/or other web content) in order to enable categorization of the specific data (e.g., categorization of the web pages and/or other web content). In some embodiments, communication between the directory builder 70 and the categorizer 72 may be conducted via the processor 60. However, the directory builder 70 and the categorizer 72 may alternatively be in direct communication with each other.

Embodiments of the present invention may utilize a database that contains categorization information for certain web content to perform categorizations of other web content. Accordingly, by analyzing the relationships between web content that is new and web content that is already categorized in the database, the categorization information already determined or stored can be extended to cover the additional content that may be accessible via the network 30. As such, for example, using categorizations of some content, it may be possible to essentially categorize the whole Internet. In some cases, the categorization quality of newly categorized content may depend on the quality of categorization information in the database. By ensuring a high quality of the database, a high quality of the overall Internet categorization can be achieved. In an exemplary embodiment of the present invention, a carefully built directory including categories and, for example, greater than one million web pages assigned to those categories may be used as the basis for further categorization. This may enable a very accurate automatic categorization of almost all other web pages in the entire web.

The directory builder 70 may be configured to build the database (e.g., a directory 74) described above, which may include a plurality of identifiers for corresponding web content (e.g., URLs for corresponding web pages) and an associated category for each respective item of web content (e.g., a categorization for each web page). The directory builder 70 may be configured to operate automatically or manually (e.g., via human input to define categories and/or to define into which category at least some web content is to be assigned). In this regard, for example, the directory builder 70 may be configured to initially create a directory structure and then fill web links into the structure. The creation of the directory structure may be accomplished based on a predefined structure including the association of content items (e.g., web pages or other web content) that may be identified by an identifier (e.g., URL or other resource identifier) with a corresponding category.

In an example of the manual building embodiment, an operator may utilize the directory builder 70 to create a category “online-stores/books”, which may be a sub-category of a larger or more general category “online-stores”. The operator may then manually assign certain web pages that are determined to have an association with books and are also on-line stores to the created category. For example, web pages such as www.amazon.com and www.books.com may be assigned to the “online-stores/books” category. The corresponding identifiers of the web pages (e.g., their respective URLs) may be stored in association with the category “online-stores/books”. The categories created may be assembled in a hierarchical, network, matrix or any other structure.

Meanwhile, in an example of an automatic building embodiment, the directory builder 70 may be configured to examine certain web pages (e.g., web pages with large numbers of hits, or large numbers of links thereto) and parse the main content on the respective web pages and/or the identifiers (e.g., URLs) of the web pages for key words (e.g., words that repeat or are positioned such that they may be indicative of a theme of the web page). Based on the key words located, the web pages may be assigned to either predefined or automatically generated categories based on the key words determined. The structure may be a predefined or intelligently determined hierarchical structure.

In some embodiments, a combination of manual and automatic directory building techniques may be employed in order to generate the directory builder 70. In an exemplary embodiment, whether manual, automatic or a combination of manual and automatic techniques is used to build the directory 74, the final directory 74 may have as many as one million or more links and one hundred thousand or more categories.

The categorizer 72 may be configured to assign categories to web pages without operator interaction based on the information stored in the directory 74. In this regard, after a suitable number or sampling of web pages or other web content have been categorized (e.g., including most commonly used or linked to web pages), the categorization of additional web content may be accomplished based on comparisons with the previously categorized content in the directory 74. The directory 74 may then be updated to include the additional web content and its corresponding categorization. In an exemplary embodiment, it may be possible to fill in categorizations for almost the complete Internet automatically using the existing structure of the directory 74. As such, existing links or associations that were manually (or automatically) inserted into the directory 74 defining the content of various categories may be used to provide basis information useful for determining which pages belong into the same categories. Some manual categorization may be done for web content that is indicated as not being suitable for automatic categorization (e.g., after failure of the system to properly categorize such web content).

In an exemplary embodiment, the categorizer 72 may be configured to use any one of multiple possible techniques for completing categorizations of web content based on existing categorizations. In this regard, for example, one technique that may be employed includes the categorization of a particular web page based on the categorizations of web pages to which the particular web page links. As such, for example, if a threshold number (e.g., two or more, a majority, a fixed percentage, etc.) of web pages to which the particular web page links have the same category, the particular web page may be assigned to the category that is shared between the web pages to which the particular web page links. Meanwhile, if several (or most) of the web pages to which the particular web page links do not have the same category, but have similar categories, then a broader category that may encompass all or a threshold percentage of the similar categories may be assigned to the particular web page.

As an example, if a web page such as ww.mycars.com/reviews/index.htm is being evaluated for categorization by the categorizer 72, the categorizer 72 may examine the web pages to which the web page links. If, for example, the web page links to: www.lamborghini.com (categorized as brands/cars/sports_car), www.sports-car.com (categorized as magazines/cars/sports_car), and www.auto-motor-sport.com (categorized as magazines/cars/sports_car), the web page may be categorized as (magazines/cars/sports_car) since at least two (which is also a majority in this case) of the linked to pages share the same category (e.g., magazines/cars/sports_car). Meanwhile, if a web page such as www.mycars.com/links.htm is being evaluated, the categorizer 72 may determine that the web page links to: www.cars.com (categorized as cars/magazines), www.car-dealer.com (categorized as cars/used cars), and wwwjokes.com (categorized as leisure/jokes), the categorizer may determine that at least two of the categories are similar in that they relate to the broader category of “cars”. Since the category “cars” is repeated two times, in this instance, the categorizer 72 may be configured to select the broader category (e.g., cars) as the category into which the evaluated web page is put.

As an alternative or supplemental categorization determination mechanism, the categorizer 72 may examine the web pages from which the evaluated web page is linked instead of examining the web pages to which the evaluated web page links. In this mechanism, the same criteria for categorization described above may be employed except that the web pages examined may be different since they are pages linked from instead of pages linked to.

As yet another alternative or supplemental categorization determination mechanism, the categorizer 72 may compare resource identifier information (e.g., URL) for a given web content item to resource identifier information (e.g., URL) for another web content item that is already categorized. In this regard, for example, web pages that have a parent URL that has already been categorized may be categorized into the same category as their respective parents. For example, if the category of www.mybooks.com/usedbooks is already known, the same category can be assigned to an evaluated web page of www.mybooks.com/usedbooks/kafka/kafka.htm. As such, for example, beginning portions of the identifiers such as portions of the URLs that precede dashes (e.g., www.mybooks.com), or if a match is initially found, portions of the URL that precede the next dash, may be compared to determine whether a parent/child relationship likely exists between two pages. If there is a match between the compared portions, the evaluated web page may be assumed to be in the same category as the already categorized page and the evaluated web page may be categorized accordingly.

As an example, if an evaluated web page has an identifier of www.mybooks.com/usedbooks/kafka/kafka.htm and is to be categorized, the beginning of the URL of the evaluated web page may be compared to the URLs of other web pages in the directory 74. As such, for example, pages such as: www.mybooks.com/usedbooks/kafka, www.mybooks.com/usedbooks, and www.mybooks.com may be recognized as web pages sharing identifier information that may indicate a parent/child relationship. If www.mybooks.com is in the category “online-stores/books” and www.mybooks.com/usedbooks is in the category “online-stores/books/used_books”, and if www.mybooks.com/usedbooks/kafka has no found categorization information, it may be determined that the evaluated web page should at least be categorized in the “online-stores/books” category. However, since the evaluated web page has a further matching portion of its URL with www.mybooks.com/usedbooks, the category of the page www.mybooks.com/usedbooks may be considered more accurate and thus, the category “online-stores/books/used_books” may be assigned to the evaluated web page. In some cases, the longest part of matching identifier information that can be found may be searched for first.

In some situations, there may be certain web pages for which the above described mechanism (e.g., matching a child page's category to that of the parent) may not work well. If so, a check may be made as to whether the category of the parent URL should be updated. In some cases, the parent's URL may be updated to match the category assigned to the child. The child's category may be assigned using one of the other methods described above (e.g., examining categories of pages linked from or linked to) or may be assigned by some other mechanism (e.g., manually). Furthermore, in some cases, it may be desirable to perform a plausibility check for certain known domains that should be excluded from using parent categories. As such, for example, the categorizer 72 may be configured to look up a list of known web hosting domains that are to be excluded from the above described way of using the categories of a parent URL to define the category of a child page.

In an exemplary embodiment, the categorizer 72 may be configured to utilize any one or all of the three mechanisms described above and possibly other mechanisms as well (or alternatively). In this regard, according to one embodiment, the categorizer 72 may be configured to perform two or more of the above described mechanisms and compare the results of each separate mechanism to determine categorization of an evaluated web page. For example, if two of the three mechanisms provide the same indication with respect to the category that would be assigned to the evaluated web page by the respective mechanisms, the category indicated by the two mechanisms may be assigned. Furthermore, in some cases, a confidence score could be associated with each mechanism by the categorizer 72 and the categorization result generated by the mechanism with the highest confidence score could be selected by the categorizer 72 as the categorization for the evaluated web page. In this regard, for example, a higher the degree of matching of categories of linked to or linked from web pages may cause a higher confidence score. Meanwhile, a higher degree of matching of URLs over multiple portions of the URLs (e.g. past a series of dashes) may also provide a higher confidence score.

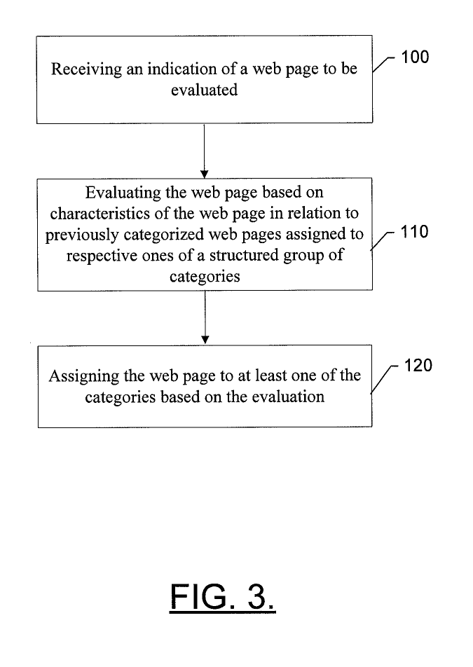

FIG. 3 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device (e.g., of the backend 22) and executed by a built-in processor (e.g., the processor 60). As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing categorization of web content as provided in FIG. 3 may include receiving an indication of a web page to be evaluated at operation 100. The indication may be received responsive to a search (e.g., over the entire Internet or another network) for content that is not yet categorized. The method may further include evaluating (e.g., using a processor configured to perform the evaluation) the web page based on characteristics of the web page in relation to previously categorized web pages assigned to respective ones of a hierarchical structure of categories at operation 110. The method may also include assigning the web page to at least one of the categories based on the evaluation at operation 120. Of note, the ordering of the operations provided in FIG. 3 is not fixed. Thus, some of the operations of FIG. 3 may be performed in a different order to achieve the same result and the order in which such operations appear in FIG. 3 should not be taken as a limiting factor.

In some embodiments, certain ones of the operations above may be modified or further amplified as described below. It should be appreciated that each of the modifications or amplifications below may be included with the operations above either alone or in combination with any others among the features described herein. In this regard, for example, evaluating the web page may include comparing a portion of a resource identifier of the web page to a corresponding portion of resource identifiers of respective categorized web pages. In such a scenario, assigning the web page to at least one of the categories may include assigning the web page to a category associated with one of the categorized web pages having a highest degree of resource identifier similarity with the portion of the resource identifier of the web page. In some cases, assigning the web page to the category associated with one of the categorized web pages having the highest degree of resource identifier similarity with the portion of the resource identifier of the web page may be performed in response to a determination that indications of a topic of the web page have at least a threshold level of similarity with indications of a topic of the one of the categorized web pages.

In an exemplary embodiment, evaluating the web page may include determining corresponding categories of pages that link to the web page. Assigning the web page to at least one of the categories may be accomplished by assigning the web page to a selected category associated with more than one of the categorized web pages in response to a determination that the categories of the categorized web pages that link to the web page or are linked to from the web page have a threshold level of similarity with each other. If the categories of the categorized web pages that link to the web page or are linked to from the web page have less than the threshold level of similarity with each other, the web page may be assigned to a selected more general category from the structured group of categories. The more general category may be associated with respective categories of more than one of the categorized web pages. A determination regarding level of similarity may be made based on pages sharing the same more general or higher level categories, based on pages sharing categories of the same level, based on a lack of contradictions or degree of contradiction, etc.

In some embodiments, evaluating the web page may include determining corresponding categories of pages that link to the web page or are linked to by the web page. Assigning the web page to at least one of the categories may then further include assigning the web page to a selected category associated with one or more of the categorized web pages in response to a determination that a threshold amount of the categorized web pages that link to the web page or are linked to by the web page are associated with the selected category. In some cases, assigning the web page to at least one of the categories may include assigning the web page to a selected more general level category from the structured group of categories, the more general level category being associated with respective categories of more than one of the categorized web pages, in response to a determination that less than the threshold amount of the categorized web pages that link to the web page or are linked to by the web page are associated with a same category. In some cases, assigning the web page to the category may include assigning the web page to a selected more general level category from the structured group of categories, in response to a determination that a topic of the category of the web page has less than a threshold level of similarity with a topic of the category of one of the categorized web pages. In this regard, the more general level category may be associated with respective categories of more than one of the categorized web pages.

In an exemplary embodiment, an apparatus for performing the method of FIG. 3 above may comprise a processor (e.g., the processor 60) configured to perform some or each of the operations (100-120) described above. The processor may, for example, be configured to perform the operations (100-120) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-120 may comprise, for example, the processor 60, the directory builder 70, the categorizer 72, and/or an algorithm executed by the processor 60 for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving an indication of a web page to be evaluated;
evaluating, using a processor configured to perform the evaluation, the web page based on characteristics of the web page in relation to previously categorized web pages assigned to respective ones of a structured group of categories; and
assigning the web page to at least one of the categories based on the evaluation.

2. The method of claim 1, wherein evaluating the web page comprises comparing a portion of a resource identifier of the web page to a corresponding portion of resource identifiers of respective categorized web pages, and
wherein assigning the web page to at least one of the categories comprises assigning the web page to a category associated with one of the categorized web pages having a highest degree of resource identifier similarity with the portion of the resource identifier of the web page.

3. The method of claim 2, wherein assigning the web page to the category associated with one of the categorized web pages having the highest degree of resource identifier similarity with the portion of the resource identifier of the web page is performed in response to a determination that indications of a topic of the web page have at least a threshold level of similarity with indications of a topic of the one of the categorized web pages.

4. The method of claim 2, wherein assigning the web page to the category comprises assigning the web page to a selected more general level category from the structured group of categories, the more general level category being associated with respective categories of one or more of the categorized web pages, in response to a determination that a topic of a category of the web page has less than a threshold level of similarity with a topic of the category of one of the categorized web pages.

5. The method of claim 1, wherein evaluating the web page comprises determining corresponding categories of pages that link to the web page, and
wherein assigning the web page to at least one of the categories comprises assigning the web page to a selected category associated with more than one of the categorized web pages in response to a determination that the categories of the categorized web pages that link to the web page have a threshold level of similarity with each other.

6. The method of claim 5, wherein assigning the web page to at least one of the categories comprises assigning the web page to a selected more general level category of the structured group of categories, the more general level category being associated with respective categories of more than one of the categorized web pages, in response to a determination that the categories of the categorized web pages that link to the web page have less than the threshold level of similarity with each other.

7. The method of claim 1, wherein evaluating the web page comprises determining corresponding categories of pages to which the web page links, and
wherein assigning the web page to at least one of the categories comprises assigning the web page to a selected category associated with more than one of the categorized web pages in response to a determination that the categories of the categorized web pages to which the web page links have a threshold level of similarity with each other.

8. The method of claim 7, wherein assigning the web page to at least one of the categories comprises assigning the web page to a selected more general level category of the group, the more general level category being associated with respective categories of more than one of the categorized web pages, in response to a determination that the categories of the categorized web pages to which the web page links have less than the threshold level of similarity with each other.

9. A computer program product comprising at least one computer-readable storage medium having computer-executable program code instructions stored therein, the computer-executable program code instruction comprising:
program code instructions for receiving an indication of a web page to be evaluated;
program code instructions for evaluating the web page based on characteristics of the web page in relation to previously categorized web pages assigned to respective ones of a structured group of categories; and
program code instructions for assigning the web page to at least one of the categories based on the evaluation.

10. The computer program product of claim 9, wherein program code instructions for evaluating the web page include instructions for comparing a portion of a resource identifier of the web page to a corresponding portion of resource identifiers of respective categorized web pages, and
wherein program code instructions for assigning the web page to at least one of the categories include instructions for assigning the web page to a category associated with one of the categorized web pages having a highest degree of resource identifier similarity with the portion of the resource identifier of the web page.

11. The computer program product of claim 10, wherein program code instructions for assigning the web page to the category associated with one of the categorized web pages having the highest degree of resource identifier similarity with the portion of the resource identifier of the web page is performed in response to a determination that indications of a topic of the web page have at least a threshold level of similarity with indications of a topic of the one of the categorized web pages.

12. The computer program product of claim 11, wherein program code instructions for assigning the web page to the category include instructions for assigning the web page to a selected more general level category from the structured group of categories, the more general level category being associated with respective categories of one or more of the categorized web pages, in response to a determination that a topic of a category of the web page has less than a threshold level of similarity with a topic of the category of one of the categorized web pages.

13. The computer program product of claim 9, wherein program code instructions for evaluating the web page include instructions for determining corresponding categories of pages that link to the web page, and
wherein program code instructions for assigning the web page to at least one of the categories include instructions for assigning the web page to a selected category associated with more than one of the categorized web pages in response to a determination that the categories of the categorized web pages that link to the web page have a threshold level of similarity with each other.

14. The computer program product of claim 13, wherein program code instructions for assigning the web page to at least one of the categories include instructions for assigning the web page to a selected more general level category from the group, the more general level category being associated with respective categories of more than one of the categorized web pages, in response to a determination that the categories of the categorized web pages that link to the web page have less than the threshold level of similarity with each other.

15. The computer program product of claim 9, wherein program code instructions for evaluating the web page include instructions for determining corresponding categories of pages to which the web page links, and
wherein program code instructions for assigning the web page to at least one of the categories include instructions for assigning the web page to a selected category associated with more than one of the categorized web pages in response to a determination that the categories of the categorized web pages to which the web page links have a threshold level of similarity with each other.

16. The computer program product of claim 15, wherein program code instructions for assigning the web page to at least one of the categories include instructions for assigning the web page to a selected more general level category from a hierarchical structure of the group, the more general level category being associated with respective categories of more than one of the categorized web pages, in response to a determination that the categories of the categorized web pages to which the web page links have less than the threshold level of similarity with each other.

17. An apparatus comprising a processor configured to:
receive an indication of a web page to be evaluated;
evaluate the web page based on characteristics of the web page in relation to previously categorized web pages assigned to respective ones of a structured group of categories; and
assign the web page to at least one of the categories based on the evaluation.

18. The apparatus of claim 17, wherein the processor is configured to evaluate the web page by comparing a portion of a resource identifier of the web page to a corresponding portion of resource identifiers of respective categorized web pages, and
wherein the processor is configured to assign the web page to at least one of the categories by assigning the web page to a category associated with one of the categorized web pages having a highest degree of resource identifier similarity with the portion of the resource identifier of the web page.

19. The apparatus of claim 18, wherein the processor is configured to assign the web page to the category associated with one of the categorized web pages having the highest degree of resource identifier similarity with the portion of the resource identifier of the web page in response to a determination that indications of a topic of the web page have at least a threshold level of similarity with indications of a topic of the one of the categorized web pages.

20. The apparatus of claim 18, wherein the processor is configured to assign the web page to the category by assigning the web page to a selected more general level category from the structured group of categories, the more general level category being associated with respective categories of one or more of the categorized web pages, in response to a determination that a topic of a category of the web page has less than a threshold level of similarity with a topic of the category of one of the categorized web pages.

21. The apparatus of claim 17, wherein the processor is configured to evaluate the web page by determining corresponding categories of pages that link to the web page, and
wherein the processor is configured to assign the web page to at least one of the categories by assigning the web page to a selected category associated with more than one of the categorized web pages in response to a determination that the categories of the categorized web pages that link to the web page have a threshold level of similarity with each other.

22. The apparatus of claim 21, wherein the processor is configured to assign the web page to at least one of the categories by assigning the web page to a selected more general level category from a hierarchical structure of the group, the more general level category being associated with respective categories of more than one of the categorized web pages, in response to a determination that the categories of the categorized web pages that link to the web page have less than the threshold level of similarity with each other.

23. The apparatus of claim 17, wherein the processor is configured to evaluate the web page by determining corresponding categories of pages to which the web page links, and
wherein the processor is configured to assign the web page to at least one of the categories by assigning the web page to a selected category associated with more than one of the categorized web pages in response to a determination that the categories of the categorized web pages to which the web page links have a threshold level of similarity with each other.

24. The apparatus of claim 23, wherein the processor is configured to assign the web page to at least one of the categories by assigning the web page to a selected more general level category from a hierarchical structure of the group, the more general level category being associated with respective categories of more than one of the categorized web pages, in response to a determination that the categories of the categorized web pages to which the web page links have less than the threshold level of similarity with each other.
